(19) United States
(12) Patent Application Publication
(10) Pub. No.: US 2013/0285956 A1
(43) Pub. Date: Oct. 31, 2013

(54) MOBILE DEVICE PROVIDED WITH DISPLAY FUNCTION, STORAGE MEDIUM, AND METHOD FOR CONTROLLING MOBILE DEVICE PROVIDED WITH DISPLAY FUNCTION

(71) Applicant: KYOCERA CORPORATION, Kyoto (JP)

(72) Inventors: Toshihiro KAMII, Osaka (JP); Tatsuya IZUMI, Osaka (JP)

(73) Assignee: KYOCERA Corporation, Kyoto (JP)

(21) Appl. No.: 13/870,766

(22) Filed: Apr. 25, 2013

(30) Foreign Application Priority Data
Apr. 25, 2012 (JP) 2012-099429

(51) Int. Cl. G06F 3/041

(52) U.S. Cl. CPC G06F 3/0416
USPC 345/173

(57) ABSTRACT

A mobile device provided with a display function includes a display surface on which a screen as a target to be operated is displayed; a touch detection module which detects a touch operation on the display surface; an operation specifying module which specifies the kind of the touch operation on the display surface on the basis of results of detection by the touch detection module; and a function execution module which executes a function according to the kind of the touch operation specified by the operation specifying module. In this configuration, the function execution module restricts execution of a function corresponding to a touch operation of a predetermined kind in a restriction area provided in at least a part of an inner peripheral edge of the display surface.

This application claims priority under 35 U.S.C. Section 119 of Japanese Patent Application No. 2012-099429 filed Apr. 25, 2012, entitled “MOBILE DEVICE PROVIDED WITH DISPLAY FUNCTION, PROGRAM, AND METHOD FOR CONTROLLING MOBILE DEVICE PROVIDED WITH DISPLAY FUNCTION”. The disclosure of the above application is incorporated herein by reference.

### BACKGROUND OF THE INVENTION

1. Field of the Invention

The present invention relates to a mobile device provided with a display function such as mobile telephones, personal digital assistant (PDA), tablet PC, digital books, portable music players, and portable TVs. The present invention also relates to a storage medium storing a computer program suitable for use in the mobile device, and a control method suitable for use in the mobile device.

2. Disclosure of Related Art

There are conventionally known a mobile telephone that includes a touch sensor on a display surface and executes various application programs (hereinafter, simply referred to as “applications”) according to touch operations performed on the display surface by a user. In such a mobile telephone, in recent years, as the size of the display surface increases, the width of a frame part surrounding the display surface is narrowed. A decrease in the width of a frame part causes the user's finger to touch an inner peripheral edge of the display surface when the user holds the mobile telephone, which may cause an error operation.

In view of the above, such a mobile telephone may be configured such that an input disabling area is provided in an inner peripheral edge of the display surface and touch input to the inner peripheral edge is disabled.

However, when a touch operation to the inner peripheral edge of the display surface is completely disabled by configuring the mobile telephone such that touch input to the inner peripheral edge of the display surface is disabled as described above, the operability of the device may be remarkably lowered, although an error operation can be prevented.

### SUMMARY OF THE INVENTION

A mobile device provided with a display function according to a first aspect of the present invention includes a display surface on which a screen as a target to be operated is displayed; a touch detection module which detects a touch operation on the display surface; an operation specifying module which specifies the kind of the touch operation on the display surface on the basis of results of detection by the touch detection module; and a function execution module which executes a function according to the kind of the touch operation specified by the operation specifying module. In this configuration, the function execution module restricts execution of a function corresponding to a touch operation of a predetermined kind in a restriction area provided in at least a part of an inner peripheral edge of the display surface.

A second aspect of the present invention relates to a storage medium storing a computer program to be applied to a computer in a mobile device provided with a display function. The mobile device includes a display surface on which a screen as a target to be operated is displayed, and a touch detection module which detects a touch operation on the display surface. The computer program provides the computer in the mobile device with a function of specifying the kind of the touch operation on the display surface on the basis of results of detection by the touch detection module; a function of executing a function according to the specified kind of the touch operation; and a function of restricting execution of a function corresponding to a touch operation of a predetermined kind in a restriction area provided in at least a part of an inner peripheral edge of the display surface.

A third aspect of the present invention relates to a method for controlling a mobile device provided with a display function, and including a display surface on which a screen as a target to be operated is displayed, and a touch detection module which detects a touch operation on the display surface. The method according to the third aspect includes the steps of specifying the kind of the touch operation on the display surface on the basis of results of detection by the touch detection module; executing a function according to the specified kind of the touch operation; and restricting execution of a function corresponding to a touch operation of a predetermined kind in a restriction area provided in at least a part of an inner peripheral edge of the display surface.

### BRIEF DESCRIPTION OF THE DRAWINGS

These and other objects, and novel features of the present invention will become more apparent upon reading the following detailed description of the embodiments along with the accompanying drawings.

FIGS. 1A and 1B are diagrams showing a configuration of a mobile telephone according to a first embodiment;

FIG. 2 is a block diagram showing an entire configuration of the mobile telephone according to the first embodiment;

FIG. 3 is a flowchart showing a process for executing a function corresponding to a touch operation on a display surface according to the first embodiment;

FIGS. 4A and 4B are diagrams describing examples, in which a tap operation and a double tap operation are designated as touch operations to be restricted according to the first embodiment;

FIGS. 5A and 5B are diagrams describing examples, in which a tap operation and a double tap operation are designated as touch operations to be restricted according to the first embodiment;

FIGS. 6A and 6B are diagrams describing examples, in which a drag operation with a first touch position in a restriction area is designated as a touch operation to be restricted according to the first embodiment;

FIGS. 7A to 7D are diagrams describing examples, in which a flick operation with a first touch position in a restriction area is designated as a touch operation to be restricted according to the first embodiment;

FIGS. 8A to 8D are diagrams describing modification examples of the restriction area according to the first embodiment;

FIG. 9 is a block diagram showing an entire configuration of a mobile telephone according to a second embodiment;

FIG. 10 is a flowchart showing a function execution process in Example 1 according to the second embodiment;

FIGS. 11A to 11D are diagrams showing restriction areas to be set according to applications according to the second embodiment;

FIG. 12 is a flowchart showing a function execution process in Example 2 according to the second embodiment;

FIGS. 13A and 13B are diagrams showing restriction areas to be set according to display directions of a screen according to the second embodiment;

FIG. 14 is a flowchart showing a function execution process in Example 3 according to the second embodiment;

FIGS. 15A to 15D are diagrams showing restriction areas to be set according to orientations of the mobile telephone according to the second embodiment;

FIG. 16 is a flowchart showing a function execution process according to a third embodiment;

FIGS. 17A and 17B are diagrams showing examples, in which a screen with an object free from restriction in a restriction area is displayed on a display surface according to the third embodiment;

FIG. 18 is a flowchart showing a display control process according to a modification example;

FIGS. 19A to 19E are diagrams showing screen display examples when the display control process is executed according to the modification example; and

FIGS. 20A to 20C are diagrams describing other examples of the display control process according to the modification example.

The drawings are provided mainly for describing the present invention, and do not limit the scope of the present invention.

### DESCRIPTION OF PREFERRED EMBODIMENTS

In the following, embodiments of the invention are described referring to the drawings.

### First Embodiment

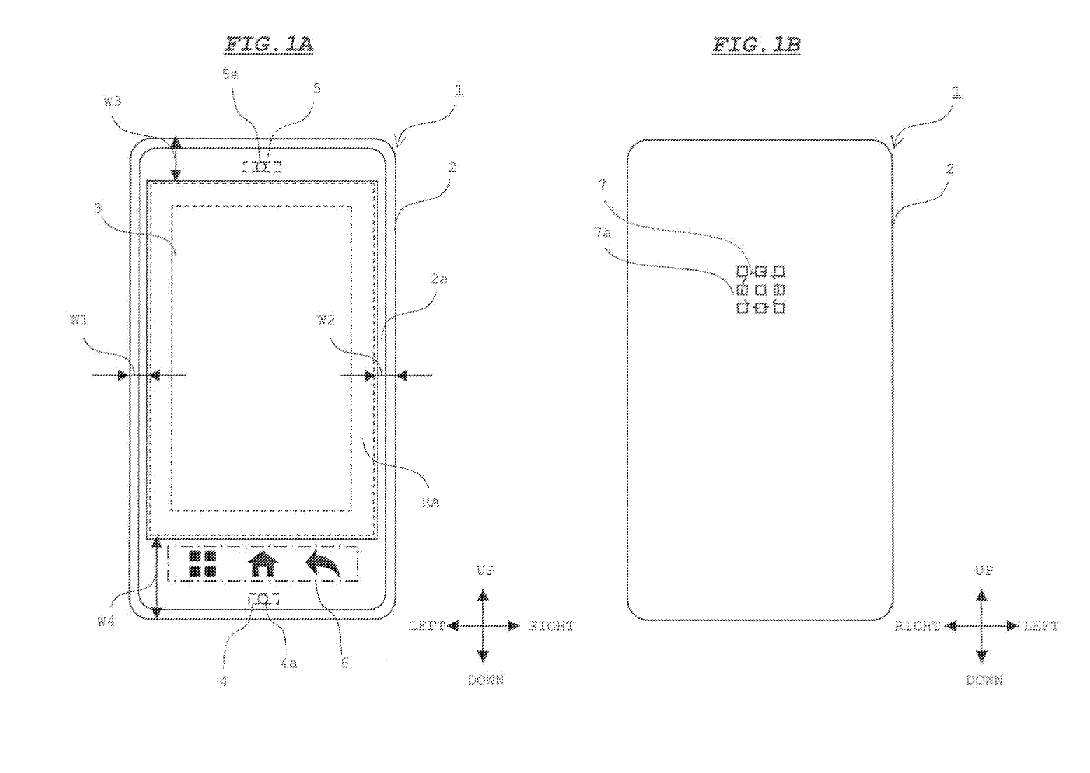

FIGS. 1A and 1B are diagrams showing a configuration of a mobile telephone 1. FIGS. 1A and 1B are a front view and a back view of the mobile telephone 1, respectively.

In the following, to simplify the description, as shown in FIGS. 1A and 1B, the lengthwise direction of a cabinet 2 is defined as up and down directions, and the shortwise direction of the cabinet 2 is defined as left and right directions.

The mobile telephone 1 includes the cabinet 2, a display surface 3, a microphone 4, the communication speaker 5, a key operation part 6, and an external speaker 7.

The cabinet 2 has an almost rectangular outline as viewed from the front side. The cabinet 2 includes on a front surface thereof a display surface 3 of a display module 13. The display surface 3 has a generally rectangular shape.

The microphone 4 is disposed within the cabinet 2 at a lower end part thereof, and the communication speaker 5 is disposed within the cabinet 2 at an upper end part thereof. Sounds are input into the microphone 4 through a microphone hole 4a formed in a front surface of the cabinet 2. The microphone 4 generates electric signals according to the input sounds. Sounds are mainly output from the communication speaker 5. The output sounds are released to the outside via an output hole 5a formed in the front surface of the cabinet 2.

The cabinet 2 includes a key operation part 6 on the front surface. The key operation part 6 includes a plurality of operation keys. The operation keys are assigned various functions according to a program under execution or the like.

The cabinet 2 includes the external speaker 7 therewithin. The cabinet 2 has on the back surface thereof an output hole 7a corresponding to the external speaker 7. Sounds (voices, notification sounds, and the like) output from the external speaker 7 are released to the outside via the output hole 7a.

In the cabinet 2, a frame part 2a surrounding the display surface 3 is constituted by upper, lower, left, and right frame segments. As described above, a space for disposing the communication speaker 5 is formed in the upper part of the cabinet 2, and a space for disposing the key operation part 6 and the microphone 4 is formed in the lower part of the cabinet 2. Accordingly, the widths W1 and W2 of the left and right frame segments are narrower than the widths W3 and W4 of the upper and lower frame segments. The width W1 of the left frame segment is equal to the width W2 of the right frame segment, and the width W3 of the upper frame segment is narrower than the width W4 of the lower frame segment.

On the display surface 3, there is displayed a screen as an object to be operated, such as execution screens of various applications. The user can perform various touch operations by contacting the display surface 3 with his/her finger, a touch pen, or the like (hereinafter, simply referred to as “finger”). The touch operations include a tap operation, a double tap operation, a long tap operation, a flick operation, a slide operation, a drag operation, and the like. In the following, these touch operations are described in detail.

The tap operation is performed by a user contacting the display surface 3 with his/her finger and then releasing the finger from the display surface 3 within a short time. The double tap operation is performed by a user repeating the tap operation on the display surface 3 twice for a short time. The long tap operation is performed by a user contacting and holding his/her finger on the display surface 3 for a determined time or longer, and releasing the finger from the display surface 3. The flick operation is performed by a user flipping the display surface 3 in an arbitrary direction with his/her finger. More specifically, the flick operation is performed by a user bringing his/her finger into contact with the display surface 3, and flipping the display surface 3 in an arbitrary direction at a determined speed with his/her finger. The slide operation is performed by a user moving his/her finger on the display surface 3 in an arbitrary direction while keeping his/her finger in contact with the display surface 3. Further, the slide operation includes a slide operation, specifically, a so-called drag operation to be performed by a user touching an object (an icon for activating an application, a shortcut icon, a file, a folder, or the like) displayed on the display surface 3 with his/her finger, and moving the object on the display surface 3.

In other words, a tap operation, a double tap operation, and a long tap operation are touch operations that do not involve moving a touch position on the display surface 3. The flick operation and the slide operation are touch operations that involve moving a touch position on the display surface 3.

A restriction area RA for restricting receiving a touch operation of a predetermined kind is provided on the entire inner peripheral edge of the display surface 3. FIG. 1A shows the restriction area RA by the broken line. A touch operation that is likely to be performed when the user's finger inadvertently touches the display surface 3, for example, a tap operation and a double tap operation are designated as a touch operation to be restricted. Further, for example, a touch operation that is less likely to be performed as an intended operation to be performed by a user, for example, a flick operation, a slide operation, and a drag operation with a position (touch position) to be touched by the user for the first time on the display surface 3 within the restriction area RA, may be designated as a touch operation to be restricted.

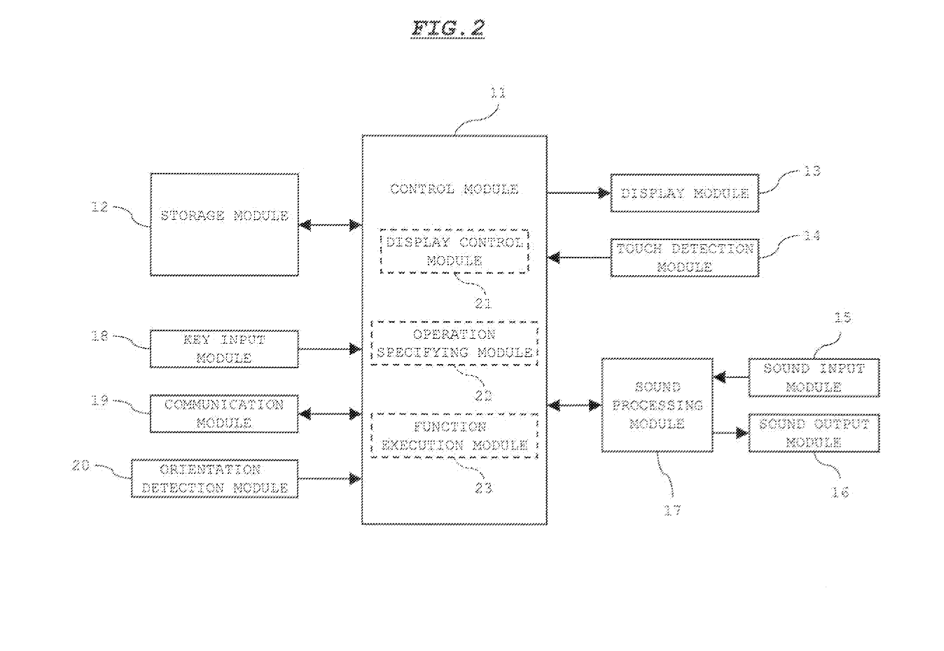

FIG. 2 is a block diagram of an entire configuration of the mobile telephone 1. The mobile telephone 1 includes a control module 11, a storage module 12, a display module 13, a touch detection module 14, a sound input module 15, a sound output module 16, a sound processing module 17, a key input module 18, a communication module 19, and an orientation detection module 20.

The storage module 12 includes a ROM, a RAM, and the like. The storage module 12 stores various programs. The programs stored in the storage module 12 include control programs for controlling components of the mobile telephone 1 and various applications (for telephone, e-mail, map, game, schedule management, for example).

The storage module 12 is also used as a working area for storing data temporarily used or generated at execution of a program.

The storage module 12 stores, as area information, position information (coordinate information) for defining the restriction area RA. Further, the storage module 12 stores touch operations (information corresponding to touch operations) designated as touch operations to be restricted.

The control module 11 includes a CPU and the like. The control module 11 controls components (the storage module 12, the display module 13, the touch detection module 14, the sound input module 15, the sound output module 16, the sound processing module 17, the key input module 18, the communication module 19, the orientation detection module 20, and others) constituting the mobile telephone 1 according to the programs.

The display module 13 includes a liquid crystal display and the like. The display module 13 displays an image (screen) on the display surface 3 according to a control signal and an image signal from the control module 11. The display module 13 may include any other display device such as an organic EL display in place of the liquid crystal display.

The touch detection module 14 includes a touch sensor and the like for detecting contact with the display surface 3 by a finger. The touch sensor is integrally formed with the foregoing liquid crystal display to constitute the touch panel. The touch sensor is formed into a transparent sheet and is disposed on the front surface of the cabinet 2 so as to cover the display surface 3. The touch sensor may be any of touch sensors of various types such as an electric capacity type, an ultrasonic wave type, a pressure sensitive type, a resistance film type, and a photo detective type.

The touch detection module 14 detects a position on the display surface 3 contacted by a finger as a touch position, and outputs a position signal corresponding to the detected touch position to the control module 11.

The sound input module 15 includes the microphone 4 and the like. The sound input module 15 outputs electric signals from the microphone 4 to the sound processing module 17.

The sound output module 16 includes the communication speaker 5, the external speaker 7, and others. The sound output module 16 inputs an electric signal from the sound processing module 17, and outputs sounds (voices, notification sounds, and the like) from the communication speaker 5 or the external speaker 7.

The sound processing module 17 subjects an electric signal from the sound input module 15 to A/D conversion and the like, and outputs a converted digital sound signal to the control module 11. The sound processing module 17 subjects a digital sound signal from the control module 11 to a decoding process and D/A conversion and the like, and outputs a converted electric signal to the sound output module 16.

When any of the operation keys in the key operation part is pressed, the key input module 18 outputs a signal corresponding to the pressed operation key to the control module 11.

To perform telephone calls and data communications, the communication module 19 includes a circuit for signal conversion, an antenna for radio wave transmission/reception, and the like. The communication module 19 converts a signal for telephone calls or data communications input from the control module 11 into a radio signal, and transmits the converted radio signal via the antenna to a base station or another communication device or the like as a destination of communications. Furthermore, the communication module 19 also converts radio signals received via the antenna into a signal in a form capable of being used by the control module 11, and outputs the converted signal to the control module 11.

The orientation detection module 20 includes an acceleration sensor and the like, detects an orientation in which the mobile telephone 1 is held by the user, and outputs a detection signal according to the detected orientation of the mobile telephone 1 to the control module 11. When the mobile telephone 1 is held in a vertical orientation (in a direction such that the lengthwise direction of the cabinet 2 is aligned with a vertical direction) by the user, a detection signal corresponding to the vertical orientation is output from the orientation detection module 20. When the mobile telephone 1 is held in a transverse orientation (in a direction such that the lengthwise direction of the cabinet 2 is aligned with a horizontal direction) by the user, a detection signal corresponding to the transverse orientation is output from the orientation detection module 20.

The control module 11 includes a display control module 21, an operation specifying module 22, and a function execution module 23.

The display control module 21 performs display control on the display module 13. For example, the display control module 21 controls the display module 13 to display a home screen in which icons for activating applications are arranged. When an application is executed, the display control module 21 controls the display module 13 to display an execution screen. Further, in the case where sleep mode is set, when a non-operation period of the mobile telephone 1 reaches a predetermined time limit, the display control module 21 turns off a backlight provided in the display module 13.

The operation specifying module 22 specifies the kind of touch operation on the basis of results of detection by the touch detection module 14. For example, when, after detection of a touch position, the touch position is not detected any longer within a predetermined first time, the operation specifying module 22 specifies that the touch operation on the display surface 3 is a tap operation. When a tap operation is detected twice within a predetermined second time, the operation specifying module 22 specifies that the touch operation on the display surface 3 is a double tap operation. When, after detection of a touch position, the touch position is continuously detected for a predetermined third time or longer and then the touch position is not detected any longer, the operation specifying module 22 specifies that the touch operation on the display surface 3 is a long tap operation. When, after detection of a touch position, the touch position moves by a predetermined first distance or longer within a predetermined fourth time and then the touch position is not detected any longer, the operation specifying module 22 specifies that the touch operation on the display surface 3 is a flick operation. When, after a touch position is detected, the touch position moves by a predetermined second distance or longer, the operation specifying module 22 specifies that the touch operation on the display surface 3 is a slide operation.

The function execution module 23 executes various functions on the basis of the kind of touch operation specified by the operation specifying module 22, and the position on the display surface 3 where the touch operation has been performed. For example, when a tap operation on an icon for activating an application is performed, the function execution module 23 activates an application corresponding to the icon on which the tap operation has been performed.

The function execution module 23 determines whether the touch operation on the display surface 3 has been performed in the restriction area RA, and whether the touch operation is a touch operation to be restricted. When a touch operation to be restricted is performed in the restriction area RA, even when a function is assigned to the touch operation, the function execution module 23 restricts execution of the function. For example, when a touch operation to be restricted is performed in the restriction area RA, the function execution module 23 disables the touch operation, and does not execute a function assigned to the touch operation.

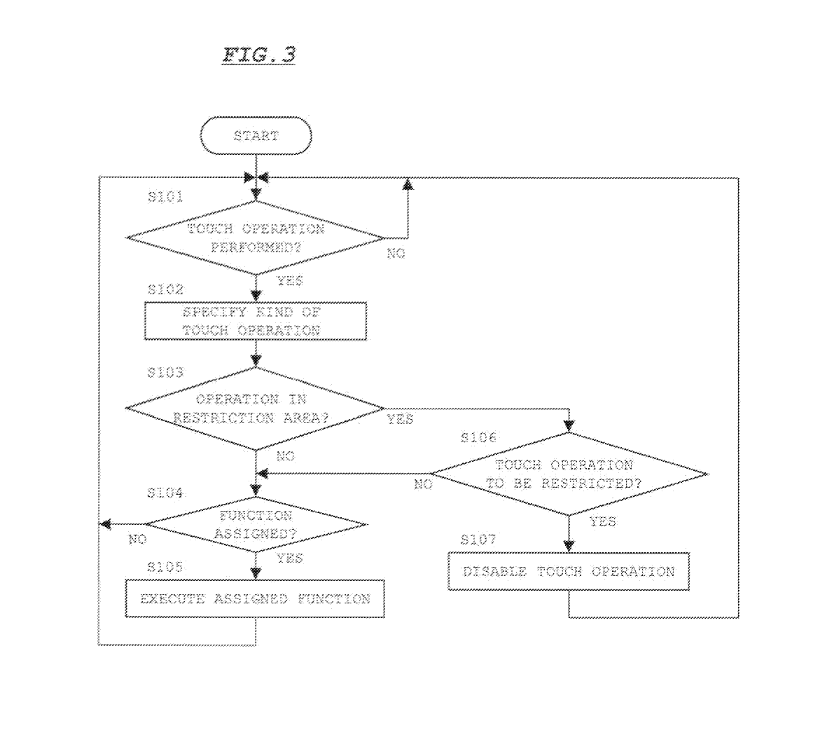

FIG. 3 is a flowchart showing a process for executing a function corresponding to a touch operation on the display surface 3. When the mobile telephone 1 is activated, the function execution process shown in FIG. 3 is started.

The operation specifying module 22 monitors whether a touch operation on the display surface 3 has been performed (S101). When a touch operation on the display surface 3 is performed (S101: YES), the operation specifying module 22 specifies the kind of the touch operation (S102).

The function execution module 23 refers to the area information stored in the storage module 12, and determines whether the touch operation on the display surface 3 is a touch operation in the restriction area RA (S103).

When a touch operation has been performed in the restriction area RA (S103: NO), the function execution module 23 determines whether a function assigned to the touch operation is present at a position on the display surface 3 where the touch operation has been performed (S104). When the function assigned to the touch operation is present at the position (S104: YES), the function execution module 23 executes the function (S105).

On the other hand, when the touch operation has not been performed in the restriction area RA (S103: YES), the function execution module 23 determines whether the touch operation on the display surface 3 is a touch operation to be restricted in the restriction area RA (S106). When the touch operation is a touch operation to be restricted in the restriction area RA (S106: YES), the function execution module 23 disables the touch operation, and does not execute a function, even when the function is assigned to the touch operation (S107).

At step S106, when the touch operation is determined not to be a touch operation to be restricted in the restriction area RA (S106: NO), and a function is assigned to the touch operation (S104: YES), the function execution module 23 executes the assigned function (S105).

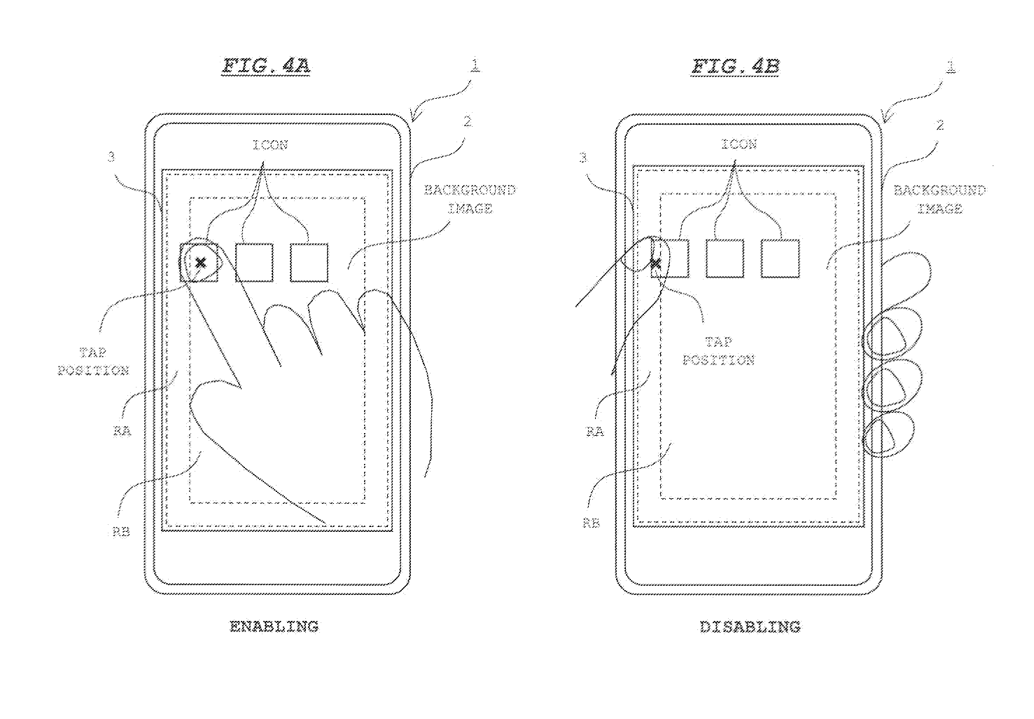

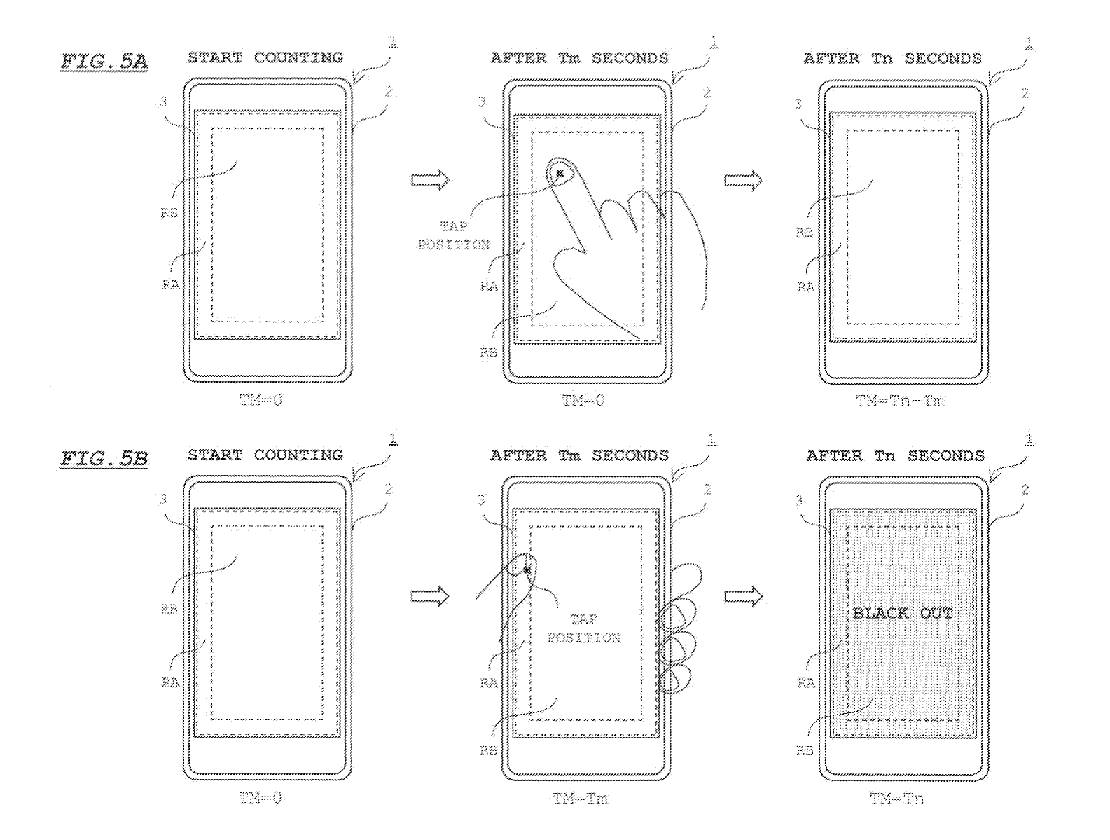

FIGS. 4A, 4B, 5A, and 5B are diagrams describing examples, in which a tap operation and a double tap operation are designated as touch operations to be restricted. FIGS. 4A and 4B show examples, in which a screen with icons for activating applications is displayed on the display surface 3. FIGS. 5A and 5B show examples, in which sleep mode is set in the mobile telephone 1.

As shown in FIGS. 4A and 4B, let it be assumed that icons for activating applications are arranged on the display surface 3 such that an end part of a certain icon overlaps the restriction area RA. In this case, as shown in FIG. 4A, when the user intentionally performs a tap operation on the icon in a center area (hereinafter, referred to as “non-restriction area RB”) with respect to the restriction area RA, the tap operation is determined to be enabled, and the function execution module 23 activates an application corresponding to the icon. On the other hand, as shown in FIG. 4B, when the user's finger inadvertently touches an end part of an icon in the restriction area RA in holding the mobile telephone 1, and the user inadvertently performs a tap operation on the icon, the tap operation is determined to be disabled, and the function execution module 23 does not activate an application corresponding to the icon. The same control is performed when the user performs a double tap operation on the display surface 3 as with the above case.

In the examples of FIGS. 4A and 4B, a scroll function assigned to a flick operation is assigned in a background image around the icons. When a flick operation is performed on the background image, a screen is scrolled even when the flick operation is performed within the restriction area RA.

As shown in FIGS. 5A and 5B, when sleep mode is set, a timer TM provided in the control module 11 counts a limit time Tn each time a touch operation on the display surface 3 ends. As shown in FIG. 5A, when a user intentionally performs a tap operation in the non-restriction area RB after a lapse of a time Tm from the previously tap operation, the tap operation is determined to be enabled, and the timer TM is reset by the function execution module 23. Thus, even after lapse of a limit time Tn from the previously touch operation, a screen is continued to be displayed on the display surface 3. On the other hand, as shown in FIG. 5B, when the user's finger touches the inner peripheral edge of the display surface 3 in holding the mobile telephone 1, and the user has inadvertently performed a tap operation, the tap operation is determined to be disabled, and the timer TM is not reset by the function execution module 23. Thus, after lapse of a limit time Tn from the previously tap operation, the backlight provided in the display module 13 is turned off by the display control module 21, and the screen blacks out on the display surface 3. The same control is performed when a double tap operation is performed on the display surface 3 as with the above case.

In the examples of FIGS. 4A to 5B, a long tap operation may also be designated as a touch operation to be restricted.

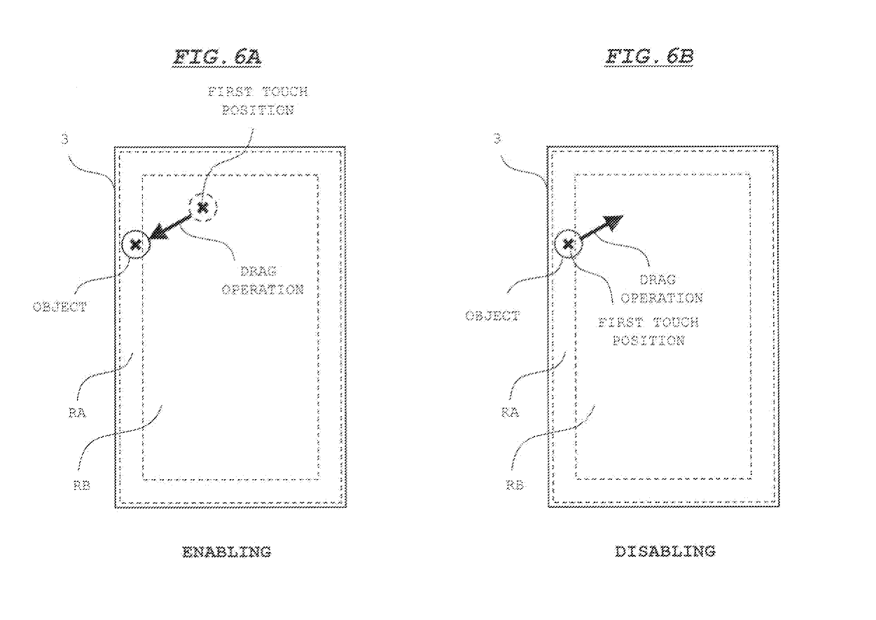

FIGS. 6A and 6B are diagrams describing examples, in which a drag operation with a first touch position in the restriction area RA is designated as a touch operation to be restricted. As shown in FIG. 6A, when a drag operation is intentionally performed by the user on an object to be moved in the non-restriction area RB, the drag operation is determined to be enabled, and the function execution module 23 moves the object to a position where the drag operation has completed, regardless of whether the position where the drag operation has completed is in the non-restriction area RB or the restriction area RA. On the other hand, as shown in FIG. 6B, when the user's finger touches an object to be moved in the inner peripheral edge of the display surface 3, and the user has inadvertently performed a drag operation on the object, the drag operation is determined to be disabled, because the first touch position is in the restriction area RA, and the function execution module 23 does not move the object, regardless of whether the position where the drag operation has completed is in the non-restriction area RB or the restriction area RA.

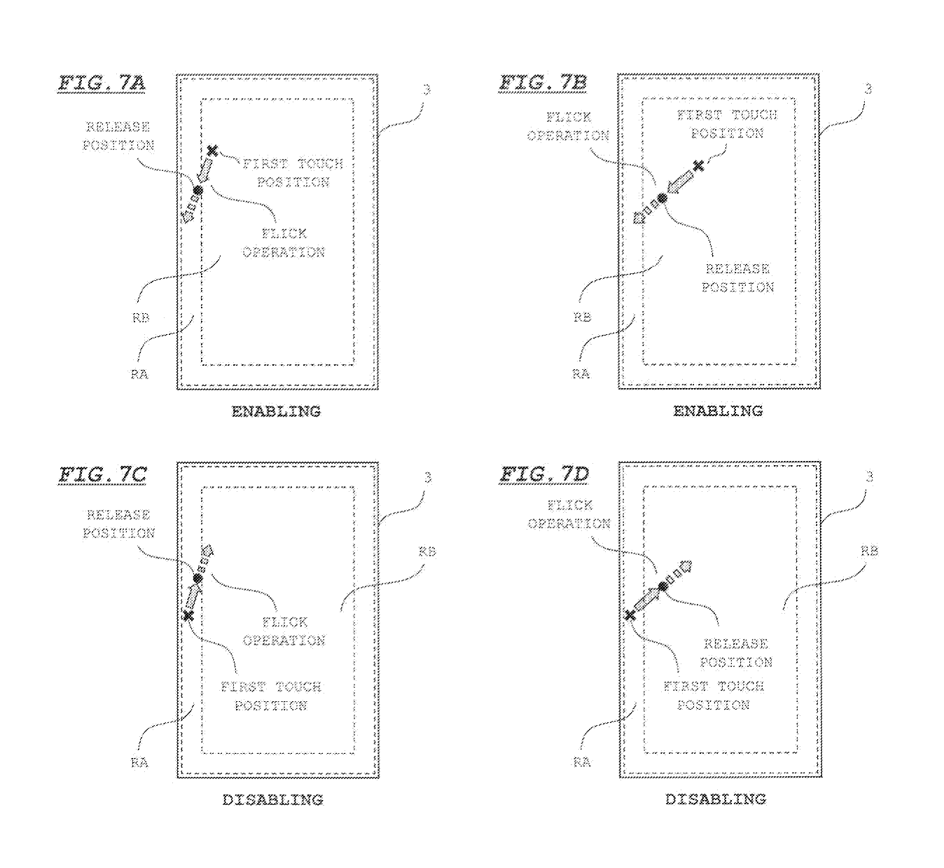

FIGS. 7A to 7D are diagrams describing examples, in which a flick operation with a first touch position in the restriction area RA is designated as a touch operation to be restricted. As shown in FIGS. 7A and 7B, when the user intentionally performs a flick operation in the non-restriction area RB, the flick operation is determined to be enabled, and the function execution module 23 executes a function assigned to the flick operation, for example, a function of scrolling a screen, regardless of whether the release position is in the non-restriction area RB or the restriction area RA. On the other hand, as shown in FIGS. 7C and 7D, when the user's finger has touched the inner peripheral edge of the display surface 3, and the user has inadvertently performed a flick operation on the inner peripheral edge, the flick operation is determined to be disabled, because the first touch position is in the restriction area RA, and the function execution module 23 does not execute a function assigned to the flick operation, regardless of whether the release position is in the non-restriction area RB or the restriction area RA.

According to this embodiment, some of the touch operations on the inner peripheral edge of the display surface 3 are disabled, and execution of the functions corresponding to the touch operations is restricted. Accordingly, execution of a function can be restricted when a touch operation which is likely to result in an erroneous operation is performed on the inner peripheral edge, and execution of a function can be performed when a touch operation which is less likely to result in an erroneous operation is performed on the inner peripheral edge. This provides the mobile telephone 1 capable of preventing an erroneous operation, while keeping a certain operability.

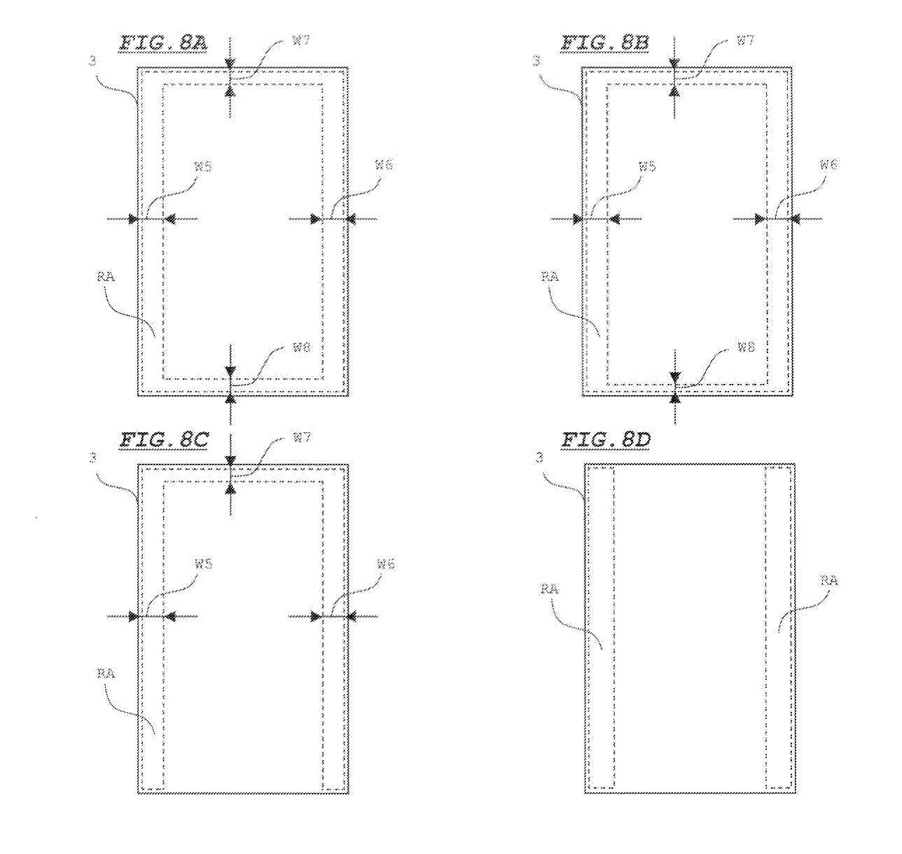

FIGS. 8A to 8D are diagrams describing modification examples of the restriction area RA.

In the embodiment, the widths of upper, lower, left, and right regions in the restriction area RA are not specifically limited. However, as described above, the frame part 2a is configured such that the widths W1 and W2 of the left and right frame segments are narrower than the widths W3 and W4 of the upper and lower frame segments. Accordingly, when the mobile telephone 1 is held, the user's finger can easily touch a position further inward from the left and right end parts of the display surface 3 than the upper and lower end parts of the display surface 3. In view of the above, as shown in FIG. 8A, the restriction area RA may be configured such that the widths W5 and W6 of the left and right regions are wider than the widths W7 and W8 of the upper and lower regions. Further, the frame part 2a may be configured such that the width W3 of the upper frame segment is narrower than the width W4 of the lower frame segment. Accordingly, as shown in FIG. 8B, the restriction area RA may be configured such that the widths W5 and W6 of the left and right regions are wider than the widths W7 and W8 of the upper and lower regions, and the width W7 of the upper region is wider than the width W8 of the lower region.

When the width W4 of the lower frame segment is sufficiently wide for the user to hold the mobile telephone 1, and it is less likely that the user's finger may touch a lower end part of the display surface 3, as shown in FIG. 8C, the lower region in the restriction area RA may be omitted. Further, when the widths W3 and W4 of the upper and lower frame segments are sufficiently wide for the user to hold the mobile telephone 1, as shown in FIG. 8D, the upper and lower regions in the restriction area RA may be omitted.

As described above, configuring the restriction area RA according to the width of each frame segment of the frame part 2a provides the mobile telephone 1 capable of preventing an erroneous operation, while keeping a certain operability in an advantageous manner.

### Second Embodiment

In the first embodiment, the shape and the size of the restriction area RA to be provided on the display surface 3 are fixed. On the other hand, in this embodiment, a restriction area RA is set according to a predetermined parameter. In other words, the shape and/or the size of the restriction area RA is changed according to a predetermined parameter.

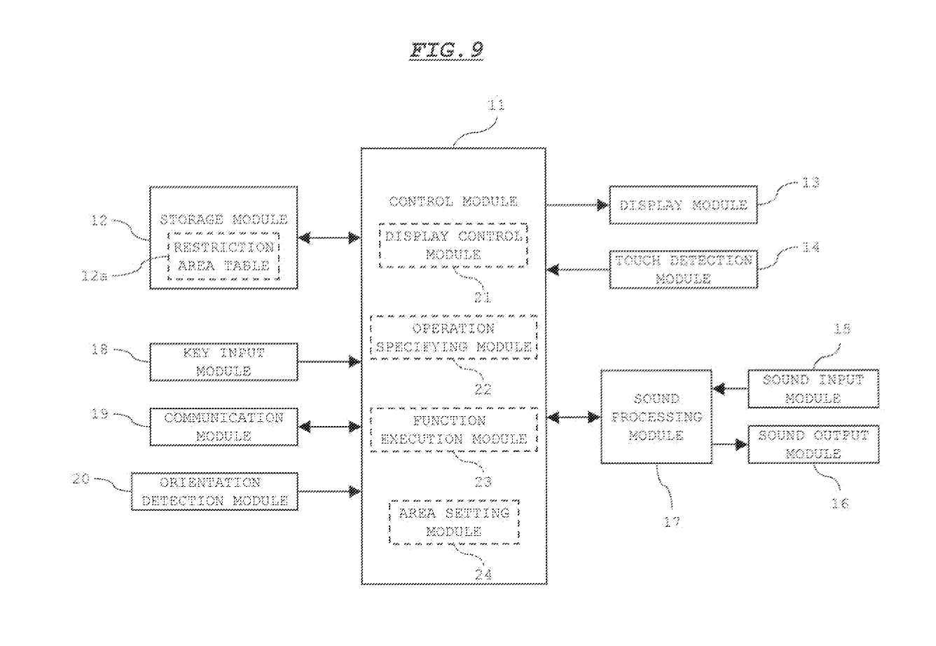

FIG. 9 is a block diagram showing an entire configuration of a mobile telephone 1.

A storage module 12 includes a restriction area table 12a. The restriction area table 12a stores restriction areas (position information defining restriction areas) of different configurations (shapes and sizes) in correspondence to respective parameters.

A control module 11 includes an area setting module 24. The area setting module 24 reads from the restriction area table 12a a restriction area RA corresponding to each parameter, and sets the read restriction area RA as a restriction area RA in the corresponding parameter.

The other configurations in this embodiment are substantially the same as with the first embodiment.

### Example 1

In this example, an application to be executed is defined as a predetermined parameter, and a restriction area RA is set according to the application to be executed. The restriction area table 12a stores restriction areas RAs in correspondence to individual applications. The area setting module 24 sets a restriction area RA according to an application to be executed.

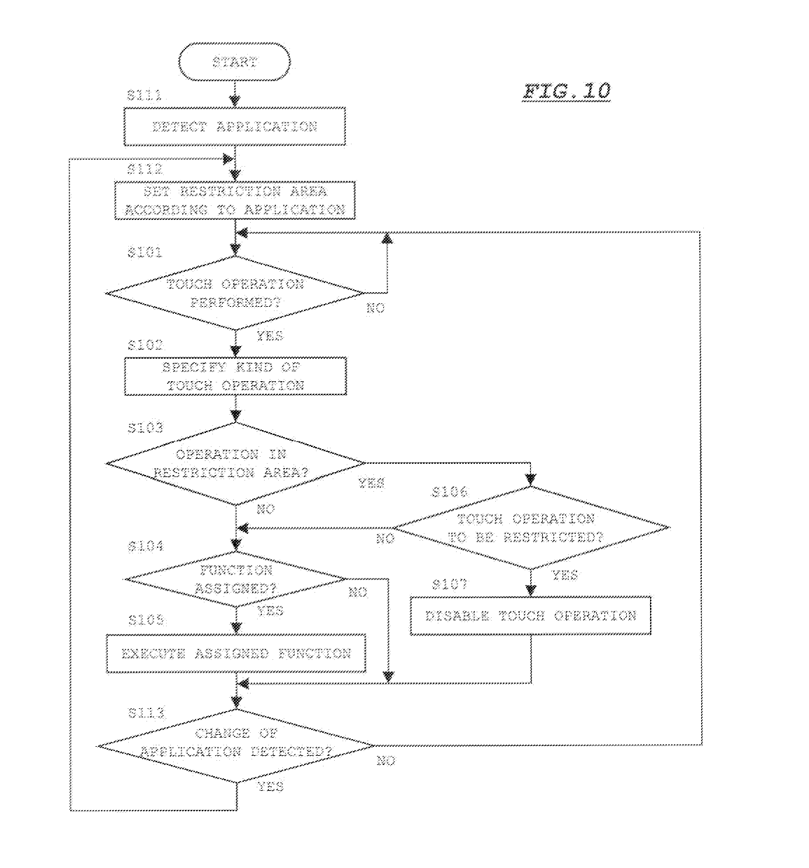

FIG. 10 is a flowchart showing a function execution process in this example.

In this example, the processes of steps S111, S112, and S113 are added to the execution process in the first embodiment shown in FIG. 3.

In this example, when the function execution process is started, the area setting module 24 detects an application to be executed (S111). The area setting module 24 sets a restriction area RA corresponding to the detected application as a restriction area RA in the detected application (S112). Further, when the area setting module 24 detects that the application to be executed has changed (S113: YES), the area setting module 24 sets the restriction area RA corresponding to a new application as a restriction area RA in the new application (S112).

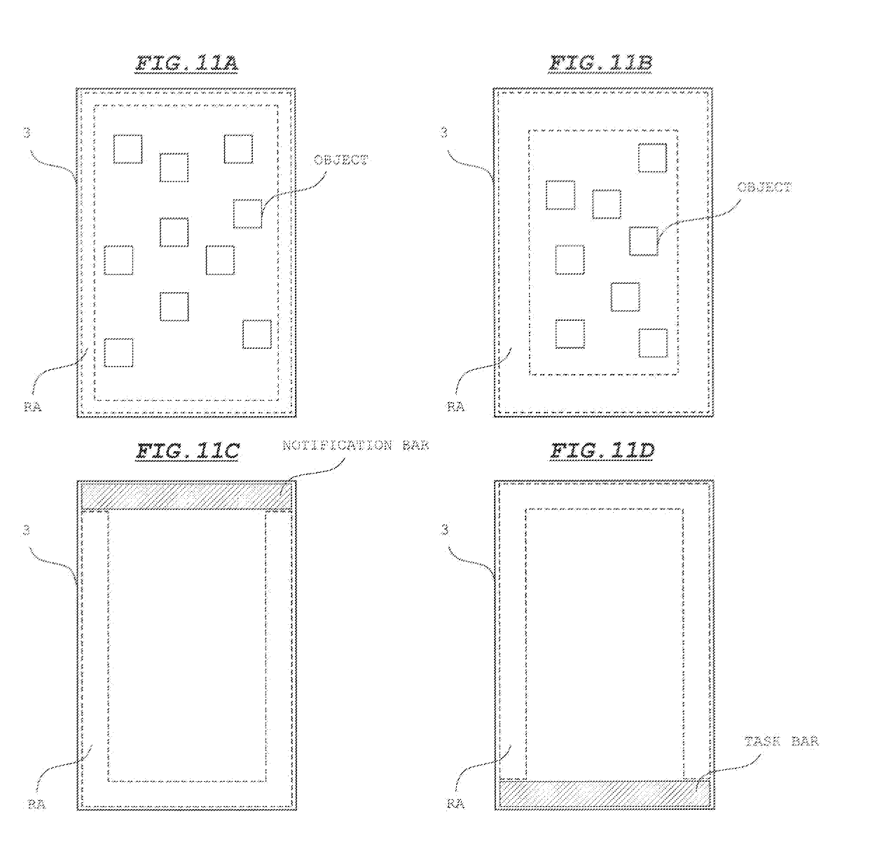

FIGS. 11A to 11D are diagrams showing restriction areas RA to be set according to applications.

For example, when an application of widely distributing objects to be operated up to an inner peripheral edge of an execution screen, as shown in FIG. 11A, a restriction area RA with narrow widths of upper, lower, left, and right regions thereof is set. The objects to be operated are icons for activating applications, shortcut icons, images in which a hyperlink is set, and the like.

When an application of arranging objects to be operated at a position close to the center of an execution screen is executed, as shown in FIG. 11B, a restriction area RA with wide widths of upper, lower, left, and right regions thereof is set.

When an application of widely distributing objects to be operated up to an inner peripheral edge of an execution screen is executed, the area setting module 24 may be inoperative to set a restriction area RA on a display surface 3.

When an application of arranging a notification bar at an upper end of an execution screen is executed, as shown in FIG. 11C, a restriction area RA constituted of a lower region, a left region, and a right region, without an upper region is set. Information relating to a mobile telephone 1 such as a remaining amount of a battery, a radio wave receiving state, and the like is notified on the notification bar. When the user performs a touch operation on the notification bar, more detailed information is notified on the display surface 3.

When an application of arranging a task bar at a lower end of an execution screen is executed, as shown in FIG. 11D, a restriction area RA constituted of an upper region, a left region, and a right region, without a lower region is set. A task bar is operated in switching between an application under execution in the foreground i.e. on the display surface 3, and an application under execution in the background.

According to this example, a restriction area RA is set according to an application to be executed. Accordingly, this makes it possible to set a restriction area RA according to a status of an execution screen. Thus, this provides the mobile telephone 1 capable of preventing an erroneous operation while keeping a certain operability in an advantageous manner.

### Example 2

In this example, a display direction of a screen to be displayed on a display surface 3 is defined as a predetermined parameter, and a restriction area RA is set according to the display direction of the screen.

A display control module 21 controls a display module 13 such that when a mobile telephone 1 is in a vertical orientation, the display direction of a screen is aligned with a direction (hereinafter, referred to as “vertical display direction”) along the lengthwise direction of the display surface 3, and when the mobile telephone 1 is in a transverse orientation, the display direction of a screen is aligned with a direction (hereinafter, referred to as “transverse display direction”) along the shortwise direction of the display surface 3.

A restriction area table 12a stores respective restriction areas RA in correspondence to the vertical display direction and the transverse display direction. An area setting module 24 sets a restriction area RA according to the display direction of a screen.

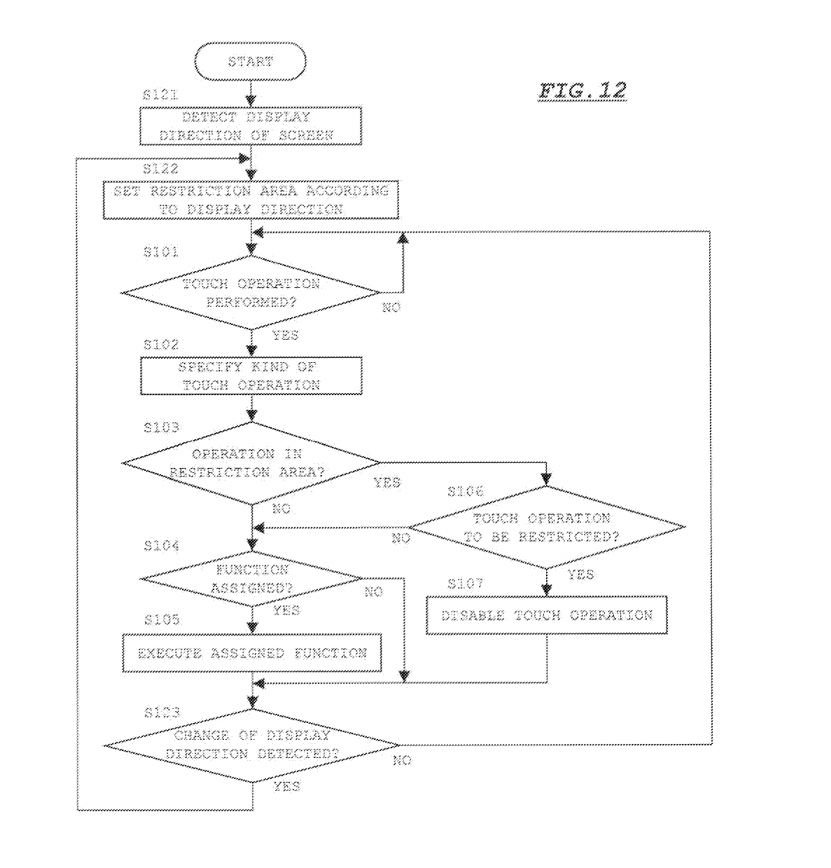

FIG. 12 is a flowchart showing a function execution process in this example.

In this example, the processes of steps S121, S122, and S123 are added to the execution process in the first embodiment shown in FIG. 3.

In this example, when the function execution process is started, the area setting module 24 detects a display direction of a screen (S121). The area setting module 24 sets a restriction area RA corresponding to the detected display direction as a restriction area RA in the detected display direction (S122). Further, when the area setting module 24 detects that the display direction of the screen has changed (S123: YES), the area setting module 24 sets the restriction area RA corresponding to a new display direction as a restriction area RA in the new display direction (S122).

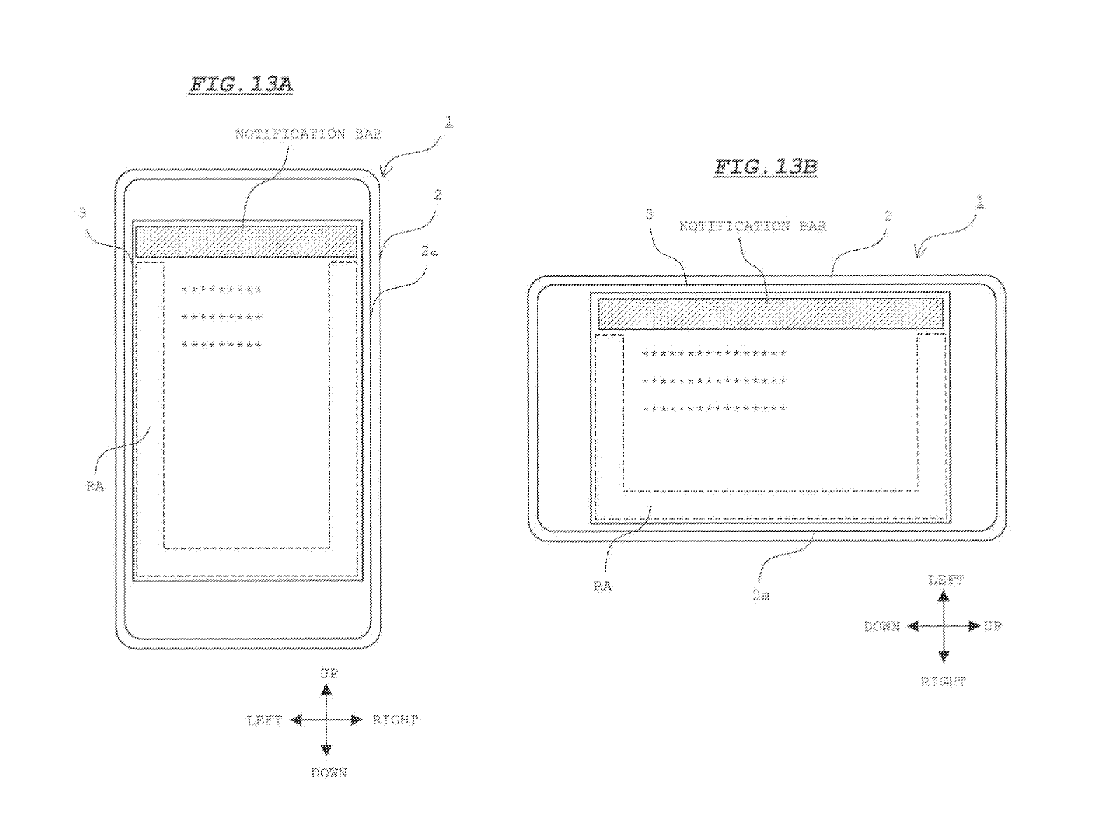

FIGS. 13A and 13B are diagrams showing restriction areas RA to be set according to the display directions of a screen.

For instance, as with the case of FIG. 11C, when an execution screen in which a notification bar is arranged at an upper end of the screen is displayed on the display surface 3, as shown in FIG. 13A, the mobile telephone 1 is in a vertical orientation, and when a screen is displayed in the vertical display direction, the notification bar is located at an upper end of the display surface 3. Accordingly, a restriction area RA constituted of a lower region, a left region, and a right region is set. On the other hand, as shown in FIG. 13B, when the mobile telephone 1 is in a transverse orientation, and the screen is displayed in the transverse display direction, the notification bar is located at a left end of the display surface 3. Accordingly, a restriction area RA constituted of a right region, an upper region, and a lower region is set.

According to this example, a restriction area RA is set according to a display direction of a screen. This makes it possible to set a restriction area RA according to a status of a screen. Thus, this provides the mobile telephone 1 capable of preventing an erroneous operation, while keeping a certain operability in an advantageous manner.

### Example 3

In this example, an orientation of a mobile telephone 1 is defined as a predetermined parameter, and a restriction area RA is set according to the orientation of the mobile telephone 1. A restriction area table 12a stores respective restriction areas RA in correspondence to a vertical orientation and a transverse orientation. An area setting module 24 sets a restriction area RA according to a determination result as to whether the orientation of the mobile telephone 1 is the vertical direction or the transverse direction.

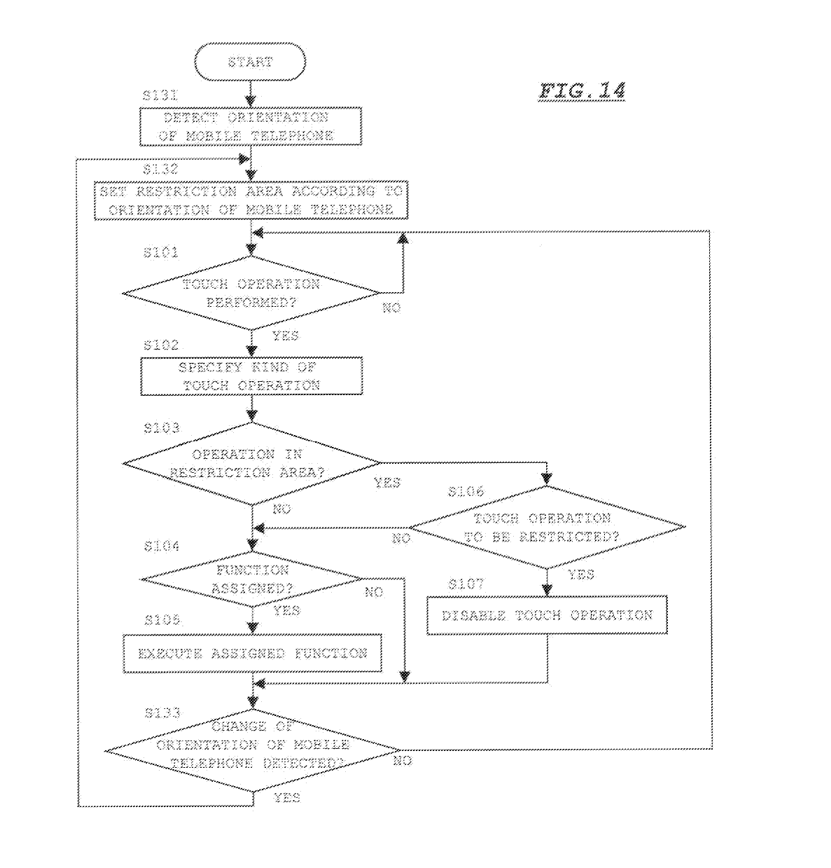

FIG. 14 is a flowchart showing a function execution process in this example.

In this example, the processes of steps S131, S132, and S133 are added to the execution process in the first embodiment shown in FIG. 3.

In this example, when the function execution process is started, the area setting module 24 detects an orientation of the mobile telephone (S131). The area setting module 24 sets the restriction area RA corresponding to the detected orientation as a restriction area RA in the detected orientation (S132). Further, when the area setting module 24 detects that the orientation of the mobile telephone 1 has changed (S133: YES), the area setting module 24 sets the restriction area RA corresponding to a new orientation as a restriction area RA in the new orientation (S132).

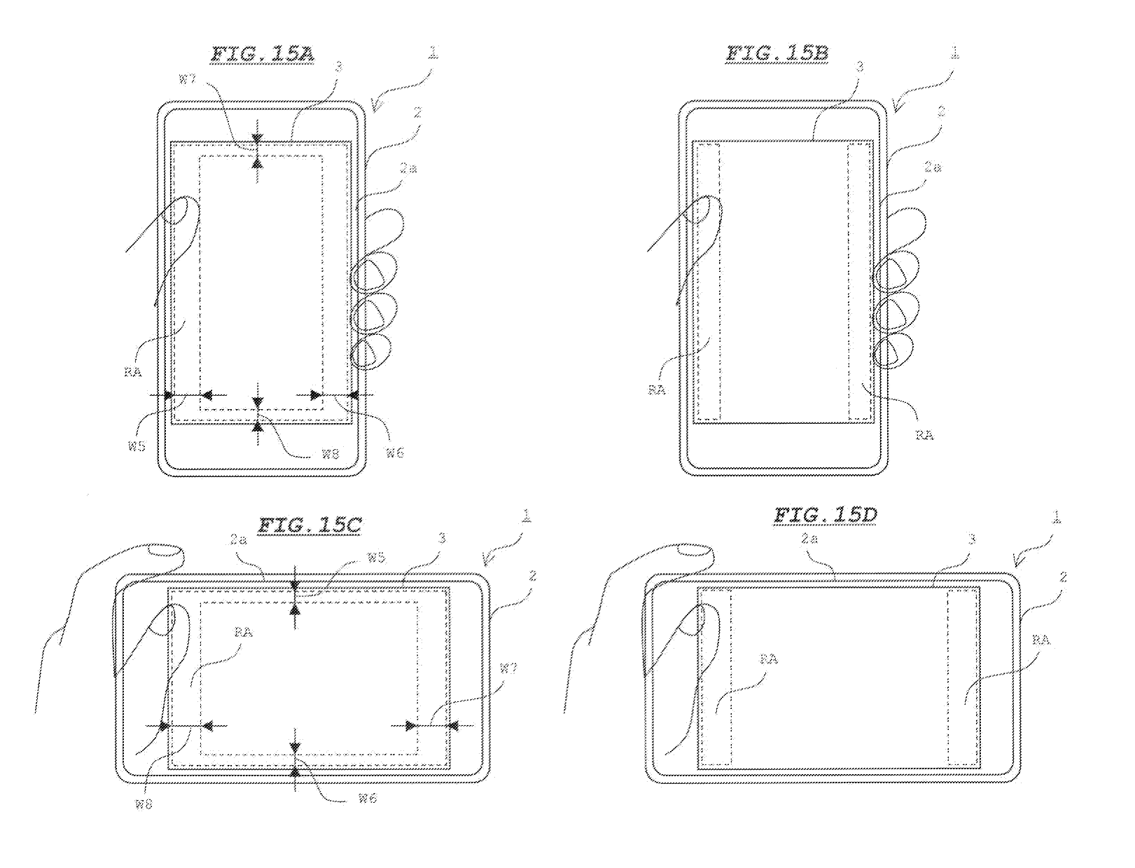

FIGS. 15A to 15D are diagrams showing restriction areas RA to be set according to the orientations of the mobile telephone 1.

For example, as shown in FIGS. 15A and 15B, when the mobile telephone 1 is in the vertical orientation, left and right frame segments of a frame part 2a are likely to be held. As a result, the user's finger may inadvertently touch left and right end parts of a display surface 3. In view of the above, in this case, as shown in FIG. 15A, the widths W5 and W6 of the left and right regions of the restriction area RA are set wider than the widths W7 and W8 of the upper and lower regions thereof. Alternatively, as shown in FIG. 15B, a restriction area RA constituted of left and right regions, without upper and lower regions may be set.

On the other hand, as shown in FIGS. 15C and 15D, when the mobile telephone 1 is in the transverse orientation, the upper and lower frame segments of the frame part 2a is likely to be held by the user. As a result, the user may inadvertently touch the upper and lower end parts of the display surface 3. In view of the above, in this case, as shown in FIG. 15C, the widths W7 and W8 of the upper and lower regions of the restriction area RA are set wider than the widths W5 and W6 of the left and right regions thereof. Alternatively, as shown in FIG. 15D, a restriction area RA constituted of upper and lower regions, without left and right regions may be set.

According to this example, a restriction area RA is set according to the orientation of the mobile telephone 1. Accordingly, this makes it possible to set a restriction area RA according to a holding manner of the mobile telephone 1 by the user. Thus, this provides the mobile telephone 1 capable of preventing an erroneous operation, while keeping a certain operability in an advantageous manner.

### Third Embodiment

In this embodiment, when a touch operation to be restricted is performed on a specific object located in a restriction area RA, a function assigned to the touch operation is executed.

A mobile telephone 1 of this embodiment includes the configurations shown in FIGS. 1A, 1B, and 2 as with the first embodiment.

Further, in this embodiment, objects (information corresponding to objects) free from restriction of operation are stored in a storage module 12.

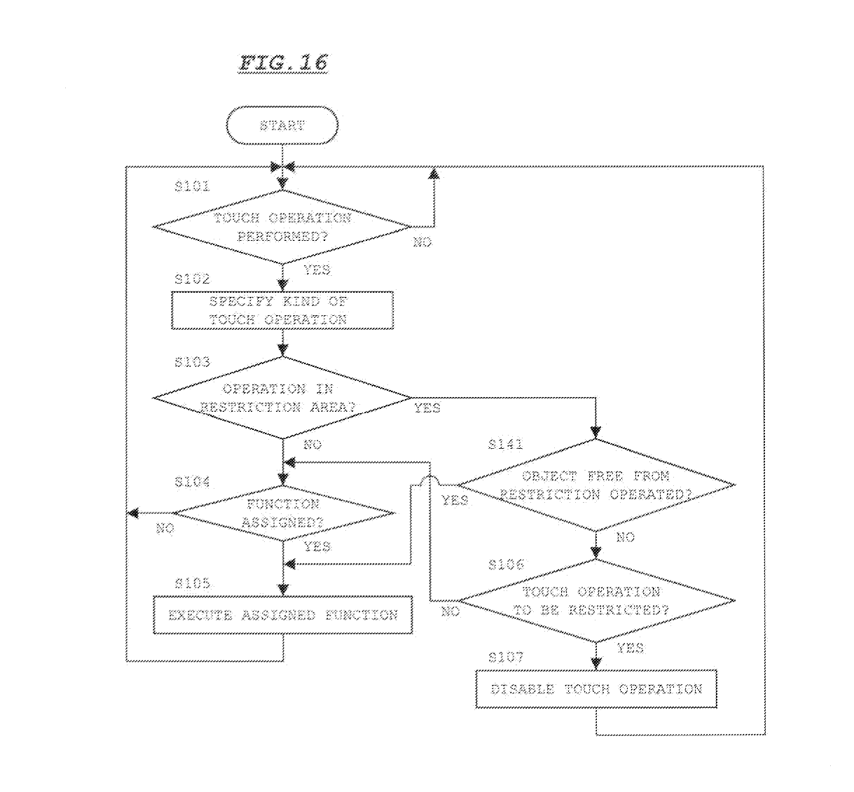

FIG. 16 is a flowchart showing a function execution process.

In this embodiment, the process of step S141 is added to the execution process in the first embodiment shown in FIG. 3.

At step S103, when a touch operation by a user is determined to be a touch operation in the restriction area RA (S103: YES), a function execution module 23 determines whether the touch operation on a display surface 3 is a touch operation on an object free from restriction (S141). When the touch operation on the display surface 3 is a touch operation on an object free from restriction (S141: YES), the function execution module 23 executes a function assigned to the touch operation (S105).

On the other hand, when the touch operation on the display surface 3 is not a touch operation on an object free from restriction (S141: NO), and the touch operation is a touch operation to be restricted (S106: YES), the function execution module 23 disables the touch operation (S107).

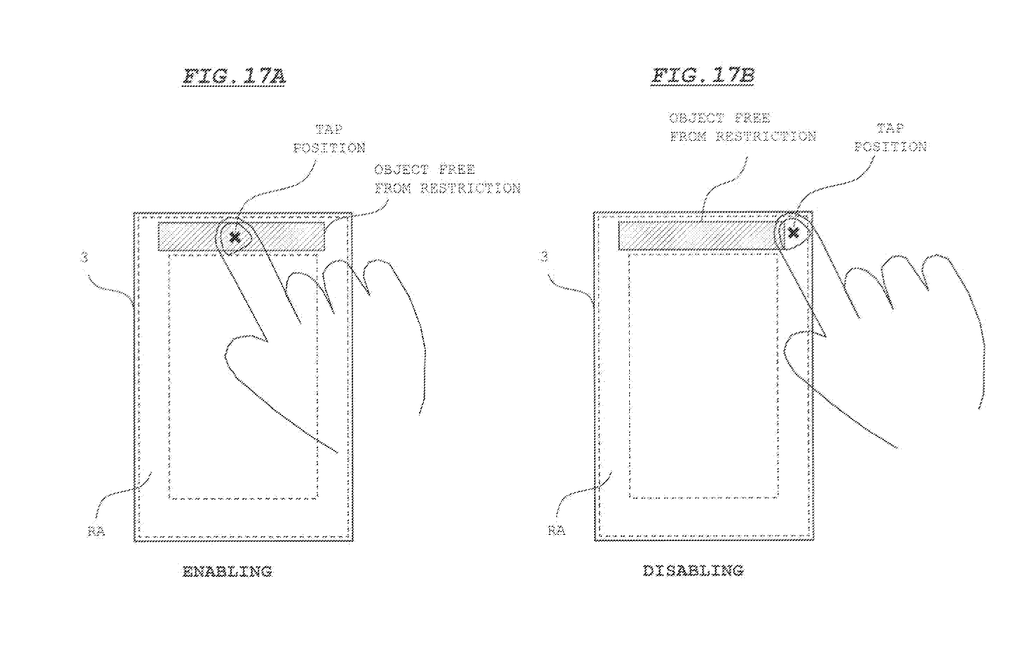

FIGS. 17A and 17B are diagrams showing examples, in which a screen with an object free from restriction in the restriction area RA is displayed on the display surface 3.

For example, when a tap operation is designated as a touch operation to be restricted, as shown in FIG. 17A, when a tap operation on an object free from restriction in the restriction area RA is performed, a function assigned to the tap operation is executed. For example, when the object is an image in which a hyperlink is set, a screen as a destination to be linked is displayed on the display surface 3.

On the other hand, as shown in FIG. 17B, when a tap operation is performed at a position other than the objects free from restriction in the restriction area RA, the tap operation is disabled. For example, as described referring to FIG. 5B, when sleep mode is set, the timer TM is not reset.

According to this embodiment, specific objects among the objects to be operated are configured to be free from restriction of touch operation. Accordingly, this provides the mobile telephone 1 capable of preventing an error operation while keeping a certain operability in an advantageous manner.

### Modification Example

The configuration of this modification example may be applied to the configurations of the first embodiment, the second embodiment, and the third embodiment.

In this modification example, a display module 13 is controlled such that objects on which a touch operation is to be restricted are arranged in a center area (non-restriction area RB) with respect to a restriction area RA on a display surface 3. The objects are icons for activating applications, shortcut icons, and the like.

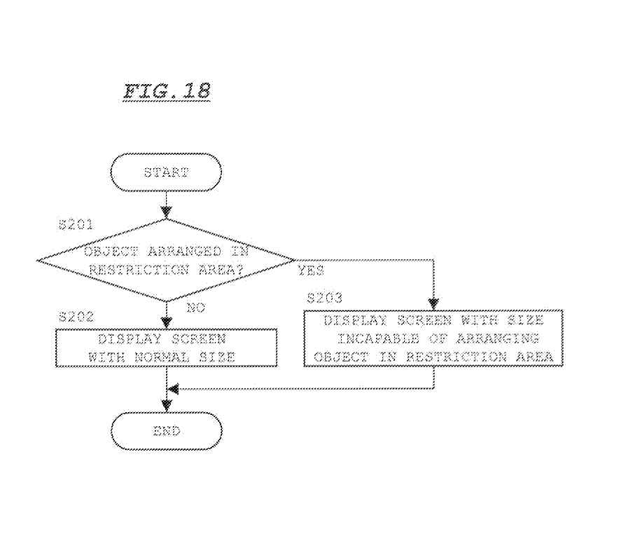

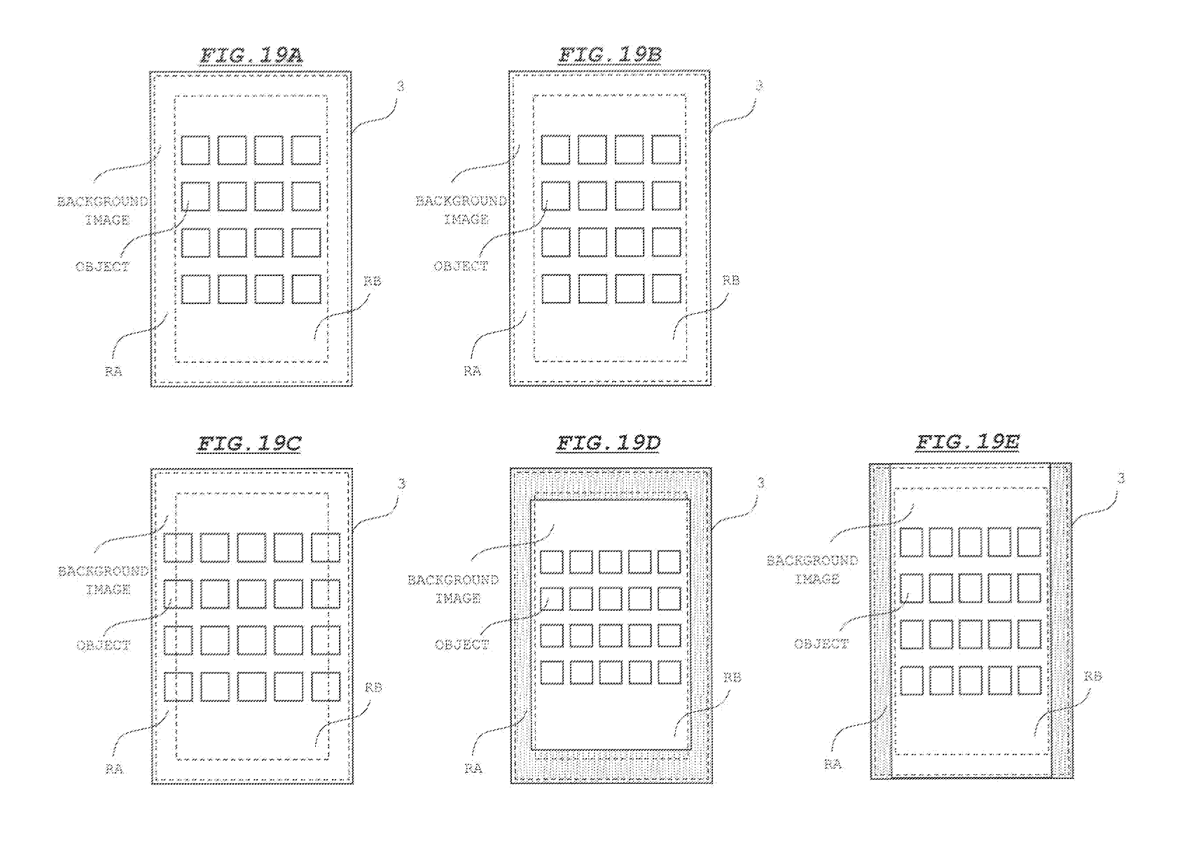

FIG. 18 is a flowchart showing a display control process. FIGs. 19A to 19E are diagrams showing screen display examples when the display control process is executed.

A display control module 21 determines, when a screen with objects on which a touch operation is to be restricted being superimposed on a background image is displayed on the display surface 3, whether the objects are to be arranged in the restriction area RA in displaying the screen with normal size (S201). When the object is not arranged in the restriction area RA (S201: NO), as shown in FIG. 19A, the display control module 21 displays the screen the display surface 3 with normal size (S202), as shown in FIG. 19B.

On the other hand, when the objects are arranged in the restriction area RA in displaying a screen at normal size (S201: NO), as shown in FIG. 19C, the display control module 21 zooms out the screen to a size incapable of arranging the objects in the restriction area RA, and displays the zoomed-out screen on the display surface 3 (S203), as shown in FIG. 19D.

As shown in FIG. 19E, it is also possible to reduce the size of a screen to be displayed on the display surface 3 in a direction along which objects cannot be located in the non-restriction area RB with normal size, for example, in left and right directions, without reducing the size of the screen in a direction along which the objects are located in the non-restriction area RB with normal size, for example, in up and down directions. In this case, the screen is displayed on the entirety of the display surface 3 in the direction along which the objects are located in the non-restriction area RB. Accordingly, the user can perform a touch operation other than the touch operations to be restricted, in the restriction area RA in the direction along which the objects can be located in the restriction area RA.

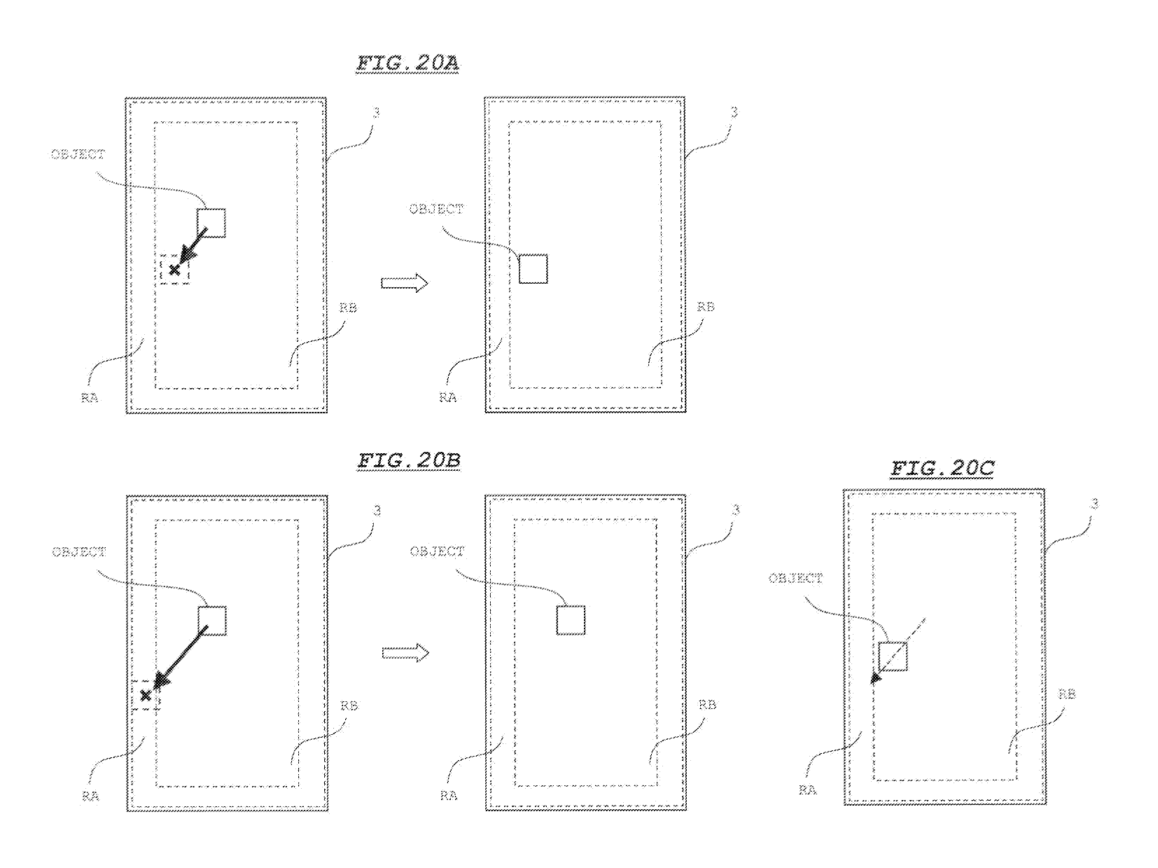

FIGS. 20A to 20C are diagrams describing another example of the display control process.

In this example, as shown in FIG. 20A, when a drag operation of an object is started in a non-restriction area RB, and the drag operation has completed in the non-restriction area RB, a display control module 21 moves the object to the position where the drag operation has completed. On the other hand, as shown in FIG. 20B, when a drag operation of an object is started in the non-restriction area RB, and the drag operation has completed in a restriction area RA, the display control module does not move the object from the original position. Alternatively, as shown in FIG. 20C, when the drag operation has completed in the restriction area RA, the display control module 21 may move the object to a position just before the object enters the restriction area RA on a trajectory of the drag operation.

According to the configuration of the modification example, an object on which a touch operation is to be restricted is not arranged in the restriction area RA. Accordingly, this makes it possible for the user to execute a function corresponding to the object, without the restriction of touch operation.

### Others

As in the foregoing, embodiments and modification examples of the present invention are described. However, the present invention is not limited by the foregoing embodiments and the like, and the embodiments of the present invention can be modified in various manners other than those described above.

For example, the configuration of the second embodiment and the configuration of the third embodiment may be combined, as necessary. Further, the configurations of Example 1 to Example 3 in the second embodiment may be combined, as necessary.

In the first embodiment, the restriction area RA is provided over the entire inner peripheral edge of the display surface 3. Alternatively, the restriction area RA may be provided in at least a part of the inner peripheral edge of the display surface 3.

Further, the restriction area RA and the non-restriction area RB, or either one of the restriction area RA and the non-restriction area RB may be displayed on the display surface 3 as an area display. Displaying the restriction area RA makes it possible for the user to recognize that an area in which a touch operation is restricted is set. Displaying the non-restriction area RB makes it possible for the user to recognize an area in which a touch operation is enabled.

In this case, the area display may be performed in displaying a new screen, when an operation of switching the screen displayed on the display surface 3 to the new screen is performed. Alternatively, the area display may be performed in displaying a new screen, when the setting of the restriction area RA or the non-restriction area RB is changed by the operation of switching to the new screen.

Further, as another configuration, the area display may be performed when the display direction of a screen is changed. Alternatively, the area display may be performed when the setting of the restriction area RA or the non-restriction area RB is changed by changing the display direction of a screen.

Further, as yet another configuration, the area display may be performed when the orientation of the mobile telephone 1 is changed. Alternatively, the area display may be performed when the setting of the restriction area RA or the non-restriction area RB is changed by changing the orientation of the mobile telephone 1.

Further, as still another configuration, the area display may be performed when a touch operation is performed. Alternatively, the area display may be performed when a touch operation to be restricted is performed. Further alternatively, the area display may be performed when a predetermined operation of notifying the user of the area is performed.

The above-mentioned area display may be performed until a predetermined time lapses after the area display is started. Alternatively, the area display may be performed until a user performs a certain operation after the area display is started.

In the first embodiment, the second embodiment, and the third embodiment, the present invention is applied to smart phone-type mobile telephones. However, the application of the present invention is not limited to this but the present invention may be applied to other types of mobile telephones such as a straight type, a folding type, and a slide type.

Further, the present invention is not limited to mobile telephones, but may be applied to various mobile devices provided with a display function, such as personal digital assistant (PDA), tablet PC, digital books, mobile music players, portable TVs, and the like.

The embodiments of the invention may be changed or modified in various ways as necessary, as far as such changes and modifications do not depart from the scope of the claims of the invention hereinafter defined.

What is claimed is:

1. A mobile device provided with a display function, comprising:
a display surface on which a screen as a target to be operated is displayed;
a touch detection module which detects a touch operation on the display surface;
an operation specifying module which specifies the kind of the touch operation on the display surface on the basis of results of detection by the touch detection module; and
a function execution module which executes a function according to the kind of the touch operation specified by the operation specifying module, wherein
the function execution module restricts execution of a function corresponding to a touch operation of a predetermined kind in a restriction area provided in at least a part of an peripheral edge of the display surface.

2. The mobile device according to claim 1, wherein
the touch operation of the predetermined kind includes a touch operation that does not involve moving a touch position on the display surface.

3. The mobile device according to claim 1, wherein
the touch operation of the predetermined kind includes a touch operation that involves moving a touch position on the display surface, with at least a first touch position being located within the restriction area.

4. The mobile device according to claim 1, further comprising:
an area setting module which sets the restriction area according to a predetermined parameter.

5. The mobile device according to claim 4, wherein
the function execution module executes an application program according to a touch operation on the display surface, and
the area setting module sets the restriction area according to the application program to be executed.

6. The mobile device according to claim 4, wherein
the area setting module sets the restriction area according to a display direction of the screen as the target to be operated.

7. The mobile device according to claim 4, further comprising:
an orientation detection module which detects an orientation of the mobile device, wherein
the area setting module sets the restriction area according to the orientation of the mobile device.

8. The mobile device according to claim 1, wherein
the screen as the target to be operated includes an object free from restriction of operation, and
the function execution module executes, when the touch operation of the predetermined kind is performed on the object displayed in the restriction area, a function assigned to the touch operation.

9. The mobile device according to claim 1, further comprising:
a display module including the display surface, and
a display control module which controls the display module, wherein
the screen as the target to be operated includes an object on which the touch operation of the predetermined kind is performed, and a background image to be superimposed on the object, and
the display control module controls the display module such that the object is arranged in an area other than the restriction area on the display surface.

10. A storage medium storing a computer program which provides a computer in a mobile device with the following functions, the mobile device being provided with a display function, and including a display surface on which a screen as a target to be operated is displayed, and a touch detection module which detects a touch operation on the display surface:
a function of specifying the kind of the touch operation on the display surface on the basis of results of detection by the touch detection module;
a function of executing a function according to the specified kind of the touch operation; and
a function of restricting execution of a function corresponding to a touch operation of a predetermined kind in a restriction area provided in at least a part of an inner peripheral edge of the display surface.

11. A method for controlling a mobile device provided with a display function, the mobile device including a display surface on which a screen as a target to be operated is displayed, and a touch detection module which detects a touch operation on the display surface, the method comprising the steps of:
specifying the kind of the touch operation on the display surface on the basis of results of detection by the touch detection module;
executing a function according to the specified kind of the touch operation; and
restricting execution of a function corresponding to a touch operation of a predetermined kind in a restriction area provided in at least a part of an inner peripheral edge of the display surface.
